(19) United States
(12) Patent Application Publication
(10) Pub. No.: US 2006/0184642 A1
(43) Pub. Date: Aug. 17, 2006

(54) System and method for creating and adminstering Web content

(76) Inventors: Michael Red, Bryant, AR (US); Lynn Hunsicker, Raleigh, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/337,504

(22) Filed: Jan. 24, 2006

Related U.S. Application Data
(60) Provisional application No. 60/645,601, filed on Jan. 24, 2005.

(51) Int. Cl. G06F 15/16

(52) U.S. Cl. 709/217; 709/223

(57) ABSTRACT

Systems and methods for creating and administering web content include receiving web content data via a user interface, storing the web content data in a database, receiving instructions from a script engine, and generating a web page from the data in the database and the instructions.

### TECHNICAL FIELD

The present invention relates generally to a system and method for creating and administering web content over an intranet.

### BACKGROUND

Businesses utilize computer networks to communicate with many people in a variety of circumstances. For example, a business may maintain two separate websites: an Internet site visible to anyone and an intranet site visible only to employees. Both types of websites provide web content in the format of pages displaying articles, memoranda, reports, test results, pictures, videos, or other kinds of information. The type of information available on a website depends on what the users will request. Users who access the Internet to, for example, browse a news source will likely encounter articles, pictures, and videos; while users of an intranet will likely encounter reports, customer information, or test data. In short, both types of websites communicate information that is related accordingly to their targeted audiences.

In the case of an intranet for a company, the size and complexity of the intranet can mushroom as the company grows. Many companies design their intranet to mirror the company's structure, either geographically or by departments. An intranet structured around departments, for example, may have separate pages for marketing, human resources, and engineering. The departments or regional offices may eventually demand, however, the ability to update part or all of their web pages. As such, it becomes difficult for a central team of web developers to serve the diverse needs of a far-flung organization; especially given the pace of business in the information age. Over time, it becomes more likely that each separate group will manage their own web pages. Although this local control shortens the time to update the information, it can lead to increased overhead costs and nonuniform web pages scattered throughout the intranet.

Moreover, most websites are created and managed by a group of employees who are experts in web programming, but not necessarily experts regarding the content of the web page they created. This is one of the main reasons why regional offices and departments request local control of their portion of the intranet. A local web programmer (the web expert) can help bridge the knowledge gap if he works closely with a group of content experts. Yet granting local control cannot entirely solve the problem of web experts versus content experts. The real experts of the content are the authors of the reports, memoranda, or articles. While web experts may command a working knowledge of the content, they rarely succeed in mastering it. Unfortunately, however, the content experts are rarely more than novice web programmers. In the end, the company must find a way to publish and share the information held by a content expert who happens to know nothing about web programming.

Accordingly, most companies must confront the disjoint of having the content expert hand over a project to the web expert. This hand-off can create a host of problems. For example, the web expert may not notice content errors because he is ignorant as to its subject matter. Also, the content expert must explain to the web expert how and where to post the web page. Moreover, the web experts can become a bottleneck if they are inundated with assignments. In an ideal world the content experts could post their own reports, and the availability of the reports would be as efficient as if the reports were posted by web experts.

In addition to the problem described above, many websites confront further problems if the website stores much more information than users routinely request. For example, an engineering company may test an entire product line before shipping and then record the test reports on the company's intranet. Even though the website stores all of the test reports, the engineers will probably review only a portion of them. Nevertheless, the engineers continue to store more reports than they review because they do not always know which reports they will need. Posting all the reports typically requires additional resources because the web server must be constantly ready to serve up any report; even though a mere handful will actually be requested. Ideally, the reports could remain in a database and the system would only display reports when users request them. This would allow the company to streamline their intranet by reducing the volume of web pages created and stored. Moreover, this approach would allow a smaller team of web experts to manage more reports, and do so from a central location. As such, the company could operate a more centralized system that will counteract the need to maintain regional web experts dispersed throughout the company.

In sum, as a company grows, the website must grow with it. Intranets in particular have a tendency to increase in complexity as a company expands. Companies that generate many reports are acutely aware of the dichotomy of web experts versus content experts. These companies can solve this by creating a centralized system that allows content experts with no knowledge of web programming to publish information on the intranet. Additionally, however, these companies must also deal with the wasted resources caused by publishing more reports than employees review. This second problem can be solved by a system that creates web pages only when users request the pages.

### SUMMARY

Disclosed is a method, system, and computer-readable medium for creating and administering web content on an intranet. The method comprises receiving survey request page design data and description data from a user; generating survey request page design instructions corresponding to the received survey request page design data; and storing the survey request page design data, design instructions, and description data in a database. The method further comprises receiving a request from a viewer to display a web page; retrieving the stored design data, stored design instructions, and stored description data from the database; generating browser-accessible code from the retrieved design data, the retrieved design instructions, and the retrieved description data; and transmitting the browser-accessible code to the viewer to display web content in the form of a survey request web page.

It is to be understood that both the foregoing general description and the following detailed description are exemplary and explanatory only and are not restrictive of the invention, as claimed.

### BRIEF DESCRIPTION OF THE DRAWINGS

FIG. 1 is an illustration of a system for creating and administering web content, consistent with the invention.

FIG. 2 is an information flow diagram for a method for creating and administering web content, consistent with the invention.

FIG. 3 is an illustration of a user interface consistent with the invention.

FIG. 4 depicts a Main Menu display of the interface of FIG. 3.

FIG. 5 depicts a Tree View display of the interface of FIG. 3.

FIGS. 6a and 6b depict an Add Page Wizard for the Add Page option of FIG. 5.

FIG. 7 depicts the layout of web pages created by the system of FIG. 1.

FIGS. 8a through 8c depict possible “zone templates” available for new web pages of the system of FIG. 1.

FIG. 9 is a sample web page created by the system of FIG. 1 for viewing by employees over an intranet.

FIG. 10 depicts a Modify View page of the system of FIG. 1.

FIG. 11 depicts a Menu View page of the system of FIG. 1.

FIG. 12 depicts a Report View page of the system of FIG. 1.

FIG. 13 depicts a Security View page of the system of FIG. 1.

FIG. 14 depicts an Edit User page of the system of FIG. 1.

FIG. 15 depicts a User Access page of the system of FIG. 1.

FIG. 16 depicts a User page of the system of FIG. 1.

FIG. 17 depicts a User Report page of the system of FIG. 1.

FIGS. 18a and 18b depict sample steps in the Content Wizard of Figure 3.

### DETAILED DESCRIPTION

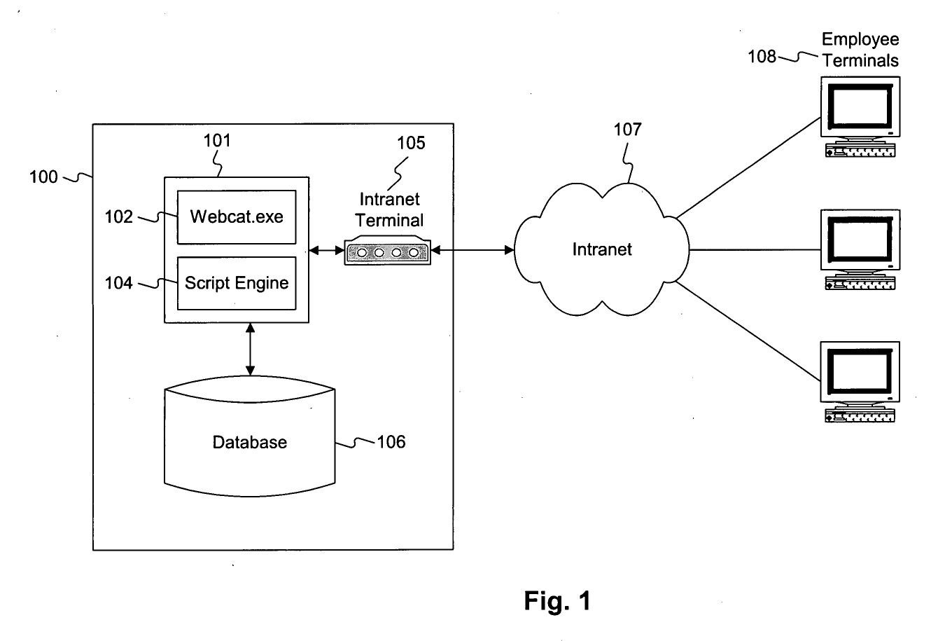

FIG. 1 is an illustration of a system and method for creating and administering web content consistent with the invention. Although the invention is described in terms of a “company” and “employees,” the invention is not so limited. It may be used with any type of organization having multiple members, for example, a university having students, a club having members, etc.

In general, most employees can access a company intranet 107. “Employees” may refer to various types of persons who have been granted access to intranet 107 (e.g., full-time employees, part-time employees, independent contractors, on-site vendors, temporary guests, etc.). However, in one embodiment, selected employees, authorized by the company as “users,” can also access a Web Content Administrative Tool system 100 to create and manage web content over intranet 107. Other employees who have been granted rights to use and view web content over intranet 107, but who have not been granted rights to use system 100, are designated as “viewers.” Further, in this embodiment, “authorized member” will refer to a person who is either a user or a viewer. Accordingly, all authorized members can browse web content on intranet 107. This definition recognizes the possibility that a subset of employees may not be granted access to browse web content on intranet 107.

Once a user is authorized, he may login at any employee terminal 108. Both users and viewers can access the web content on intranet 107 by requesting a web page with a standard Internet browser such as, for example, Internet Explorer. When system 100 receives a request for a web page through intranet terminal 105, it responds by invoking an executable software module 102, which compiles design instructions taken from a script engine 104 and data from a database 106 into browser-accessible code, such as Java or HTML, and transmits the code to employee terminal 108. If a viewer were to view the code on the browser, the code would appear the same as if a web programmer coded the page by hand. In sum, system 100 allows users to access web pages on demand from data stored on a database 106 that is converted into web pages using executable software module 102 with the instructions generated by script engine 104.

In this embodiment both executable software module 102 and script engine 104, located within processor 101 of system 100, are coded in ColdFusion. Another language, however, could be used to write the code, for example, C++.

Intranet 107 contains web pages available to authorized members on company premises. While most authorized members restrict their use of intranet 107 while on company premises, the company can also make intranet 107 entirely or partially available to authorized members working remotely. Thus, intranet 107 can be designed to allow authorized members to access intranet 107 while they are off company premises.

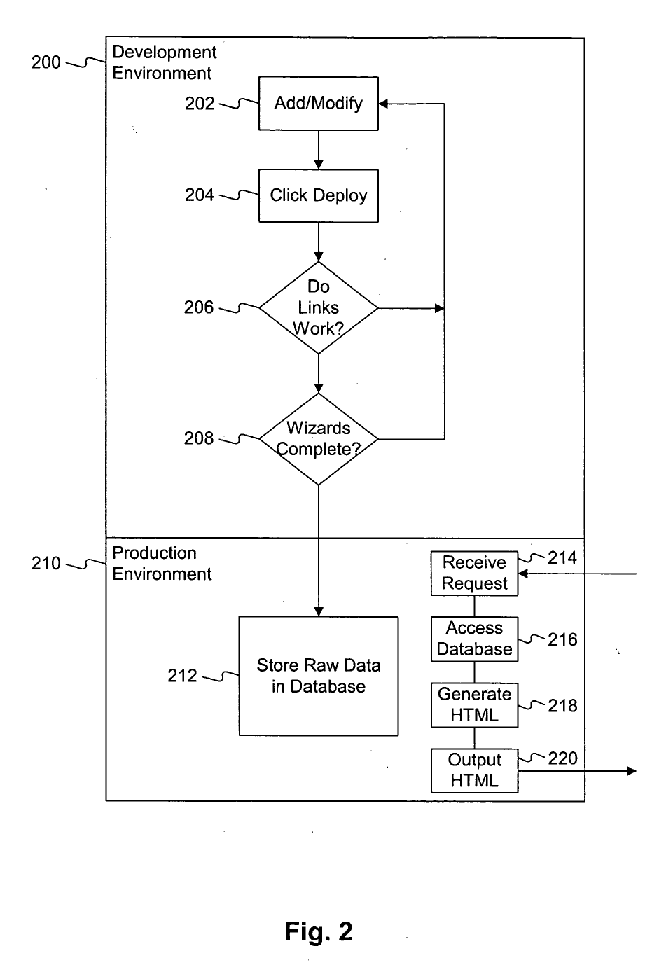

FIG. 2 is an information flow diagram for a method for creating and administering web content, consistent with the invention. The method is divided into two environments: a development environment 200 and a production environment 210. Development environment 200 performs the creation and management of web content. Production environment 210 stores the created content and operates as a web server when authorized members request web pages.

System 100 provides a simplified website development environment 200 and automatically maintains the website's production environment 210. The system allows people with absolutely no knowledge of web development to create and maintain their web pages. Users maintain web pages and page content via templates and “wizards” that walk them through various activities. A wizard is a tool that guides users step-by-step through complicated tasks by requesting simple information and hiding the complicated elements from the user. Thus, users can accomplish complicated tasks by simply filling in text boxes and making selections from drop-down lists.

Once a user has completed a particular web page, he is ready to push the web content into production environment 210 where the page is accessible to anyone on intranet 107. While in development environment 200, the user can, for example, supply information to add or modify a page 202. Upon completing the modified page, the user clicks a “Deploy” button 204. Next, system 100 verifies that the links function properly 206 by pointing to legitimate web content. Then system 100 verifies that the wizards used to modify the page have been completed 208. From the user's perspective, the wizard easily creates complicated new web content with a few clicks of the mouse or a few keystrokes. If either the links do not work or the wizards have not been completed, the user must go back and fix the problems. However, if the links work and the wizards are complete, the data is stored 212 on database 106 within production environment 210. The data stored in production environment 210 is converted to browser-accessible code (e.g., HTML or Java) when an authorized member requests a particular page from employee terminal 108. After intranet terminal 105 receives the request 214, processor 101 accesses data in database 106 in step 216 and then transforms the data into browser viewable code 218. Finally, system 100 sends the output browser-viewable code 220 to the employee terminal 108.

A feature of this embodiment illustrated in FIGS. 1 and 2 is that web pages are not created until an authorized member requests a page. After an authorized member requests a particular page, executable software module 102 generates the code (e.g., HTML, Java, etc.) using data retrieved from database 106 and instructions received from script engine 104. Accordingly, all content is stored in the database 106 and is transformed into browser-accessible code only when requested. Because system 100 is streamlined in this manner, it can support many websites without requiring excessive resources.

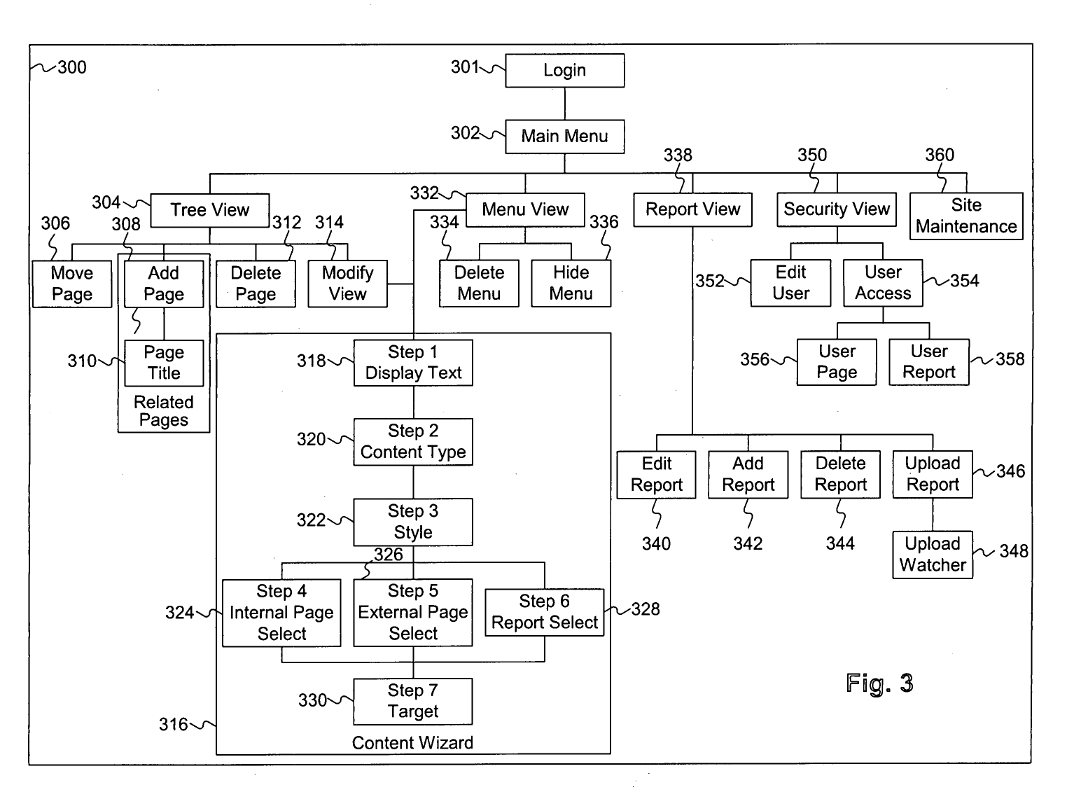

FIG. 3 is an illustration of a user interface 300 of system 100 consistent with the invention. A user may log in 301 and view a main menu 302. From the main menu a user may have several options, for example: (1) Tree View 304; (2) Menu View 302; (3) Report View 338; (4) Security View 350; and (5) (Site Maintenance (360). Each of these views has subparts that may allow the user to add, modify, or delete pages; to manipulate the menus; to add, upload, or modify reports; to access the security aspects of users; and maintain intranet 107.

Under Tree View 304, the user may view the hierarchical outlay of web content, much like a user can view a file structure with Windows® Explorer. Tree View 304 shows each web page and their parent/child relationships. In Tree View 304, a user can Move a page 306; Add a page 308; Delete a page 312; or modify a page through the Modify View 314. When the user adds a page, system 100 prompts the user to supply a title 310 for the page. Clicking on Modify View 314 allows the user to view existing pages and modify their contents. That is, the user can, for example, select a link currently pointing to the human resources department and change it to point to the marketing department.

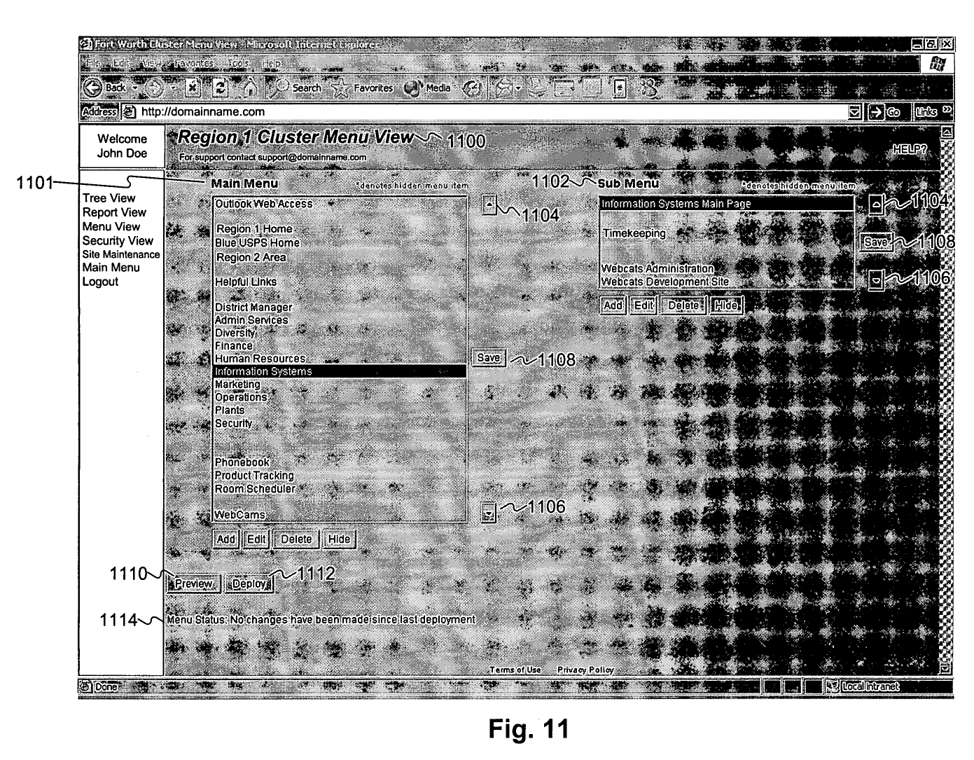

Menu View 332 allows the user to look at the menu, which is the list of items on the left-hand side of the pages on intranet 107 (explained further by FIG. 11). From the Menu View 332 the users can modify pages; add menus and submenus; or modify the order of the items on the menu. They can also delete 334 or even hide 336 items on the menu.

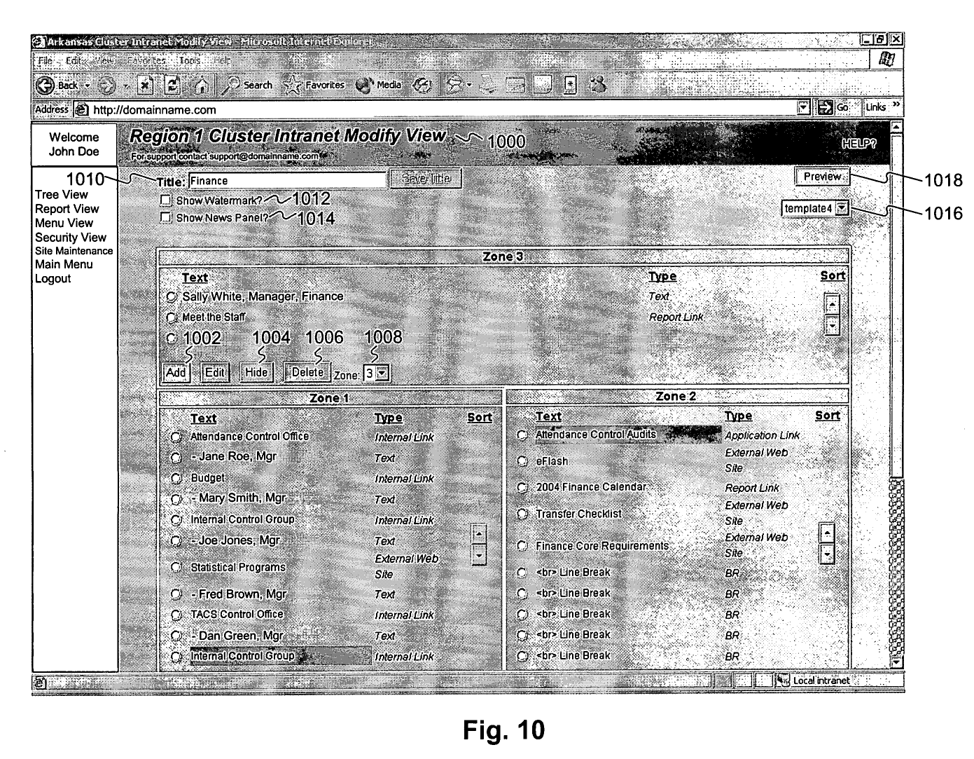

From both Tree View 304 and Menu View 332 the user can access a Content Wizard 316. Content Wizard 316 will be explained in full in the description of FIG. 10.

Report View 338 allows users to Edit reports 340; Add reports 342; Delete reports 344; or Upload reports 346. System 100 also provides an Upload Watcher 348 that oversees the process of uploading reports.

Security View 350 allows users to edit 352 new or existing user security profiles or define a user's security access 354. From a user access link 354, a user can also modify a user page 356 or a user report 358.

When a user logs in, system 100 may limit the functions available to the user, based on that particular user's level of security clearance. This embodiment contains four separate security levels. First, a user may be authorized as a Global Administrator, the highest and broadest security clearance. The next highest clearance is that of a Site Administrator, followed by Section Administrator, and finally, the lowest clearance available, a Document Manager. A Document Manager only has privileges to update reports via a report upload utility. A Section Administrator has all the privileges of the Document Manager, but she can also manage pages within a specific section of intranet 107 by adding, deleting, or moving pages within her section. Similarly, a Site Administrator has privileges of lower levels, and further can add users, grant users' rights, or restrict users to specific sections of the site. Lastly, a Global Administrator has all privileges of lower levels, and further can grant administrator privileges by creating users with lower security clearance. The levels of security clearance allow various users to appropriately create and modify content without hindering the security of system 100.

Finally, Site Maintenance 360 allows Global Administrators to create, deploy, or delete a URL on intranet 107. Only Global Administrators may utilize this feature. Moreover, this option may be hidden from view when users other than a Global Administrator view Main Menu 302.

Administrative Login Page

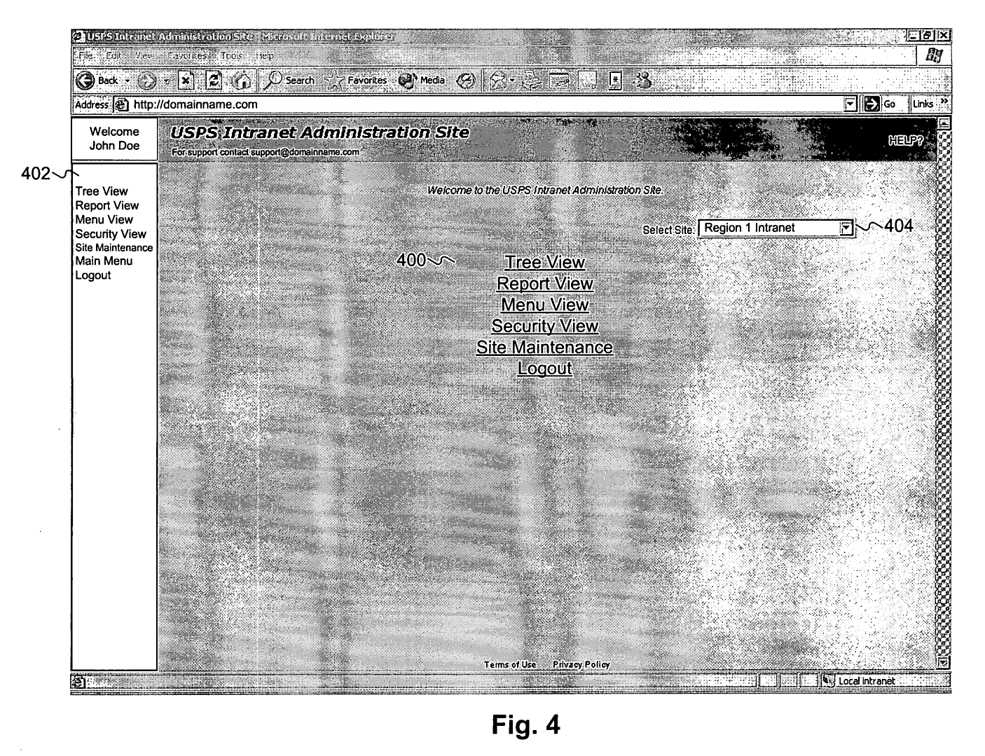

FIG. 4 depicts an example of a system 100 interface for Main Menu 302. This page provides access to the other administrative areas of the site. Depending on the user's authorization level, the user can select from one of several links 400: Tree View 304; Report View 338; Menu View 332; Security View 350; and Site Maintenance 360. As the user navigates through system 100, the left side of the page may maintain the same list as the Main Menu 302. This allows the user to easily jump to another area rather than constantly backtracking to Main Menu 302. As can be seen, the options on list 402 are identical to those found on Main Menu 302.

Depending on the level of security clearance, some users will have the ability to create, modify, and delete multiple websites. By selecting a website from drop-down box 404, users can select which website they will edit.

Tree View

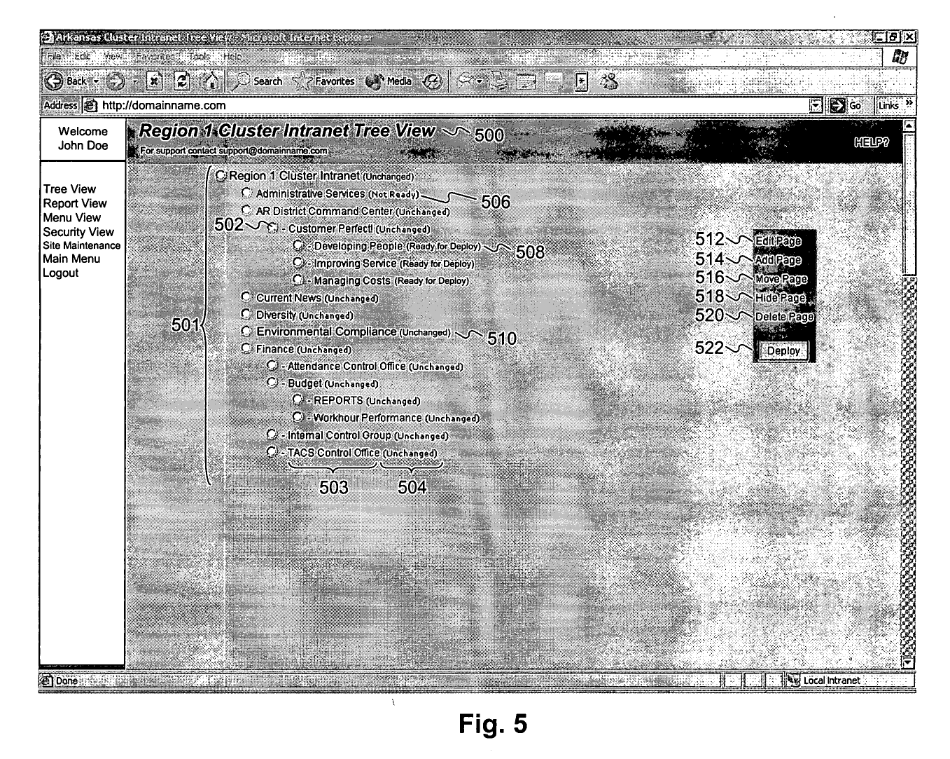

FIG. 5 depicts a web page that may be displayed to a user as Tree View page 304. This page displays a hierarchical listing 500 of all pages within the selected site, based on their parent/child relationships. System 100 displays both a title 502 and status 504 of each page on intranet 107. Users will only see the portion of the website they have permission to modify.

From Tree View 500 a user may edit, add, move, hide, delete, or deploy a web page, for example, by selecting an option from links 512, 514, 516, 518, 520, or 522, respectively. The user must first select a page before choosing an action. A “radio button,” such as 502, is used to facilitate selection of web pages and may be displayed next to the title field 503 identifying each web page. For example, upon selecting a page and clicking on Edit Page 512, system 100 takes the user to a Modify View page 314 (FIG. 3, also depicted in FIG. 10). Several of the options, such as Add Page 514, will invoke Content Wizard 316 (FIG. 3, to be described below). In addition, the security settings can be configured to allow or deny users access to the functions described above.

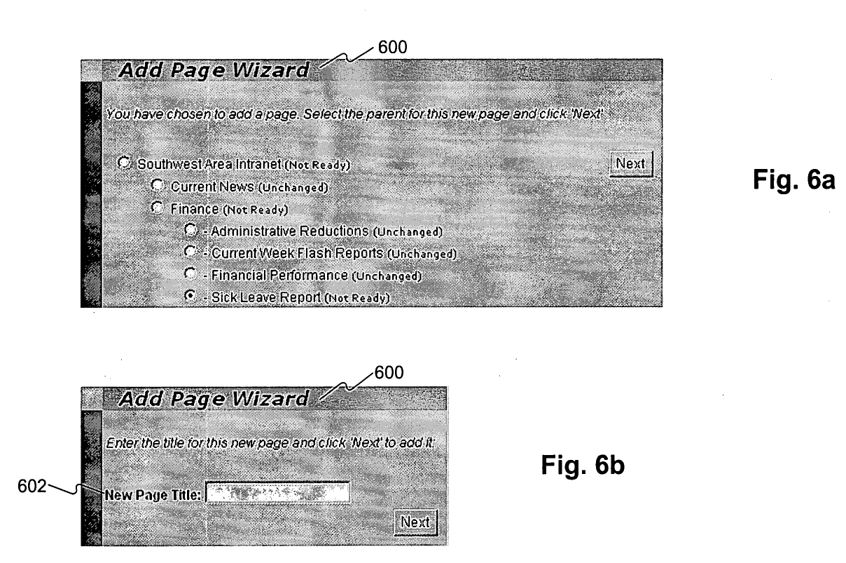

A page can be moved from one section to another by selecting a Move Page 516 option. The user must select (by clicking the radio button) the page he wishes to move and then click on Move Page 516 action. Next, system 100 opens a Move Page Wizard, which guides the user in a step-by-step manner through the process of moving a page from one location to another. The user simply selects a new parent page and then the Wizard relocates the page under its new parent page. System 100 may also create a link on the new parent page, which contains the same information as defined in an Add Page Wizard (to be described with respect to FIGS. 6a & 6b).

Users can also hide pages so authorized members cannot see the page on intranet 107. The user must select the page to be hidden and click on Hide Page 518. Afterwards, the hidden page is marked with an asterisk in Tree View page 500.

Users can delete pages from system 100 with Delete Page option 520. Deleting a page will require the user to verify that he wants to delete the page. If the user attempts to delete a page that contains any child pages, System 100 will show an error and will not allow the parent page to be deleted until the child pages have been moved or deleted. Finally, the page is not deleted from the production environment until a successful deployment has been performed.

Several pages throughout system 100, including Tree View 500, identify the status 504 of the web content. System 100 may provide several status identifiers, for example, this embodiment has three: Not Ready 506, Unchanged 510, or Ready for Deploy 508. Not Ready 506 refers to a newly created page or a page that has been changed, but not yet marked Ready for Deploy 508. Unchanged 510 refers to a page that has been successfully deployed, but no further edits have been made to the page since deployment. Ready for Deploy 508 refers to a page that the user has completed and is prepared to deploy.

When all necessary additions and edits have been made to a page, the page may be marked as Ready for Deploy 508. To mark a page as Ready for Deploy 508, the user simply checks the Ready for Deploy box on Modify View page 314 (FIGS. 3 and 10, this checkbox is not shown in FIG. 10). Parent pages cannot be marked as ready to deploy until all of their corresponding child pages have been deployed. If a user attempts to mark a parent page as Ready for Deploy 508 before all of the corresponding child pages have been deployed, an error will appear.

Once all desired pages have been marked as Ready for Deploy 508, the user clicks on the Deploy 522 option on Tree View page 500. System 100 verifies that the new or modified pages are operational as illustrated in FIG. 2. After system 100 successfully transfers the pages from the development environment 200 to the production environment 210, the user will receive a confirmation notice. All pages previously marked Ready for Deploy 508 are then assigned the Unchanged 510 page status.

Add Page

FIG. 6a depicts the display provided to the user for Add Page Wizard 600. To add a page to the site, a user selects the appropriate parent page from the page listing on Tree View page 500 and clicks on Add Page 514. Next, Add Page Wizard 600 opens and the user again selects the parent page. The new page may be associated to the parent page in several ways. A link to the new page is automatically created on the parent page. This link cannot be removed from the parent page, and the parent page cannot be deleted unless all child pages are first removed. If the user wishes to cancel Add Page Wizard 600, the Cancel button may be selected and no additional information will be inserted into the system page structure. Finally, the user must enter a title 602 for the new page that will identify the page in title field 503 on the Tree View page 500 (see FIG. 6b).

Page Layout

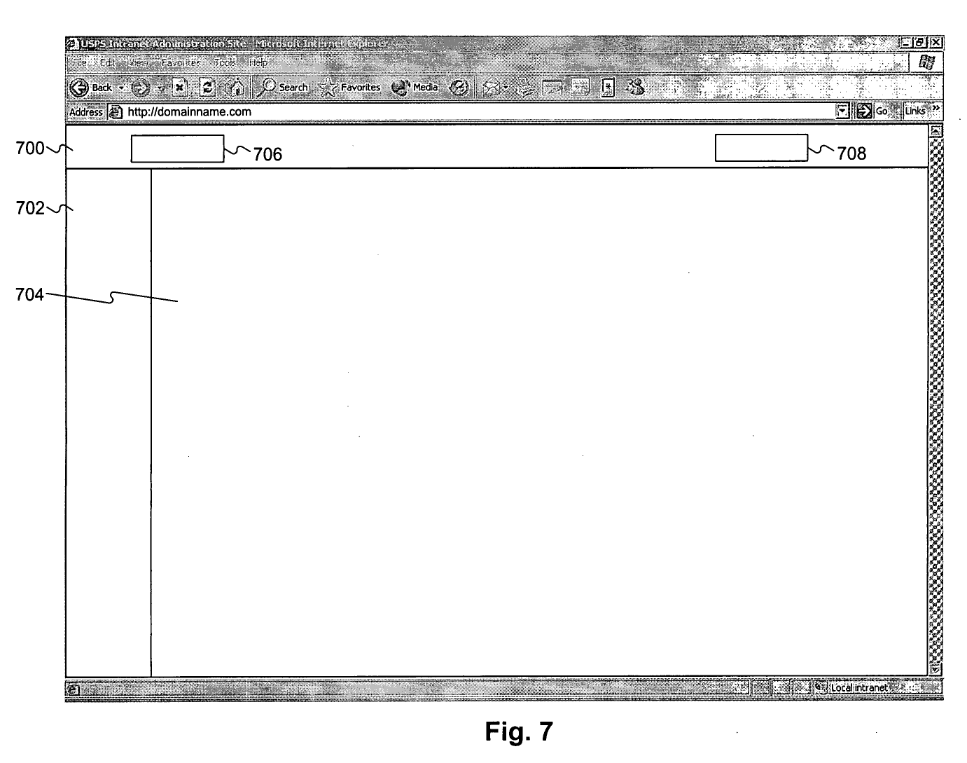

FIG. 7 depicts an exemplary layout of web pages created by system 100. In one embodiment, system 100 restricts the content a user may add to three regions. Region 700 is generally fixed for each page within a section on intranet 107. For example, the Cincinnati, Ohio, and Anchorage, Ak., district offices operate different sections within the same intranet 107. Region 700 contains a link 706 to a publicly accessible Internet page (e.g., www.usps.com) and another link 708 to the local district office section of intranet 107 (e.g., Cincinnati's intranet 107 homepage). Next, the menus added through the Menu View 332 will reside in region 702 (FIGS. 3 and 11). Most users, however, will work within region 704, which is where new pages and reports are added. One of the strengths of system 100 is that a central team of web developers can define the look and feel of the entire intranet 107 through these regions.

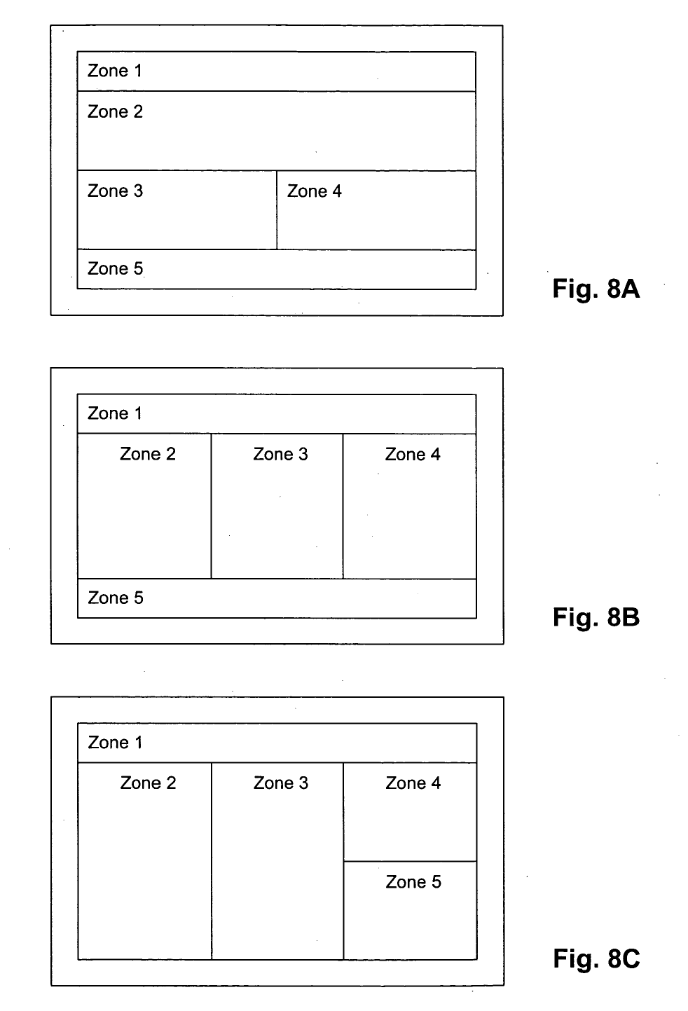

FIGS. 8a through 8c depict exemplary “zone templates” available for new web pages. In the described embodiment, each new page added will be restricted to predefined zones. The zones differ from the regions in FIG. 7 because the zones correspond only to the new page that is confined within the region 704. As authorized members browse intranet 107, they will observe that the appearance of regions 700 and 702 generally remains the same while the appearance of the web content in region 704 can change dramatically. Because each new page added may utilize one of many different zone templates, the arrangement of information within region 704 will change from page to page.

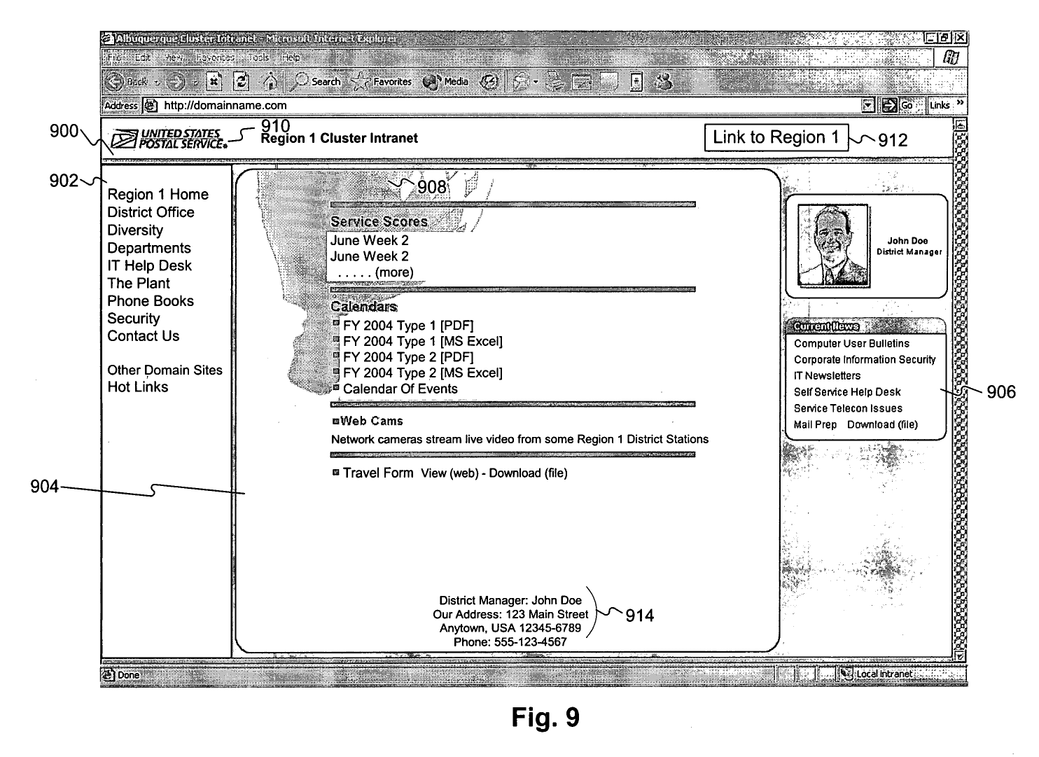

FIG. 9 is a sample web page created by system 100 and shown as viewed over intranet 107 by employee terminal 108 (FIG. 1). Region 900 of FIG. 9 corresponds to region 700 of FIG. 7, and may contain a link 910 to a website available to the public over the Internet and another link 912 to the local district office section of intranet 107. Region 902 corresponds to region 702 of FIG. 7 and contains the menu. Both 900 and 902 generally stay the same as an authorized member navigates intranet 107. As described above, however, each new web page can have different zones within region 704 of FIG. 7, which corresponds to region 904. In this sample web page, the address 914 of the office of the District Manager is in a footer zone within region 704/904.

Modify View

FIG. 10 depicts a web page that may be displayed to a user as Modify View page 1000 on system 100. All page content is controlled by Modify View page 1000. To access Modify View page 1000, the user selects a page from the hierarchical listing on Tree View page 500 and then clicks on the Edit Page 512 option from the menu on the right hand side of the page (FIG. 5). The user will then be taken to the Modify View page 1000. From here, content can be added, edited, hidden, deleted, or moved by selecting an option from links 1001, 1002, 1004, 1006, or 1008, respectively. Also, changes to the display of the page can be made, such as changing the page title 1010, showing or hiding the watermark 1012, showing or hiding the news panel 1014, or changing the overall page layout by selecting a different template 1016.

As explained earlier with FIGS. 8a to 8c, system 100 groups content by zones. Each page template contains a different number of zones in various layouts on the screen. In Modify View 1000 the user can select different templates “on the fly” by choosing the templates offered in dropdown menu 1016 (i.e., the page's layout immediately changes when a user selects a new template).

A Show Watermark checkbox 1012 allows the user to select whether they would like for the site watermark 908 to be shown on the currently active page. Similarly, the Show News Panel checkbox 1014 allows the user to choose if they would like to show the news panel on the currently active page. The news panel is depicted as item 906.

As noted earlier, FIG. 10 includes a checkbox where the user can mark a page Ready for Deploy 508 (FIG. 5). This checkbox is located at the bottom of the screen shown in FIG. 10, but could not be included because of space limitations.

Finally, users can preview what a page will look like on intranet 107 by clicking on a Preview button 1018. This option allows users to view the end product while they are still operating in the development environment.

Content Wizard

Users can add new items to the page through Content Wizard 316 (FIG. 3). To add an item to the active page, the user should select the Add button 1001 located in the zone where the new material is being added. Content Wizard 316 will then prompt the user to enter Display Text 318 for the new page item. This is the text that will be visible on the web page when authorized members view it with a browser (i.e., in the production environment 210 of FIG. 2). Next, Content Wizard 316 prompts the user to enter a Content Type 320 for the new page item. Users can select from several Content Types 320, for example: link to an internal page, link to applications on this site, link to a report, text, line break, link to another website, and so forth. The Content Type 320 chosen will determine what further information is required by Content Wizard 316 as well as how the item will function in the production environment 210.

Next, Content Wizard 316 will prompt the user to enter a Style 322 in which the new item should be displayed on the page in the production environment 210 (again, FIGS. 2 and 3). The user may preview any of the given Styles 322 by simply clicking on the style name in the style dropdown menu. This will change the Display Text 318 shown to reflect the Style 322 as it will appear on the page in production environment 210. Style 322 formats available include, for example: basic text, header, sub-header, footnote, picture caption, and so forth.

The Content Type 320 that was previously selected for the page item will determine the information required on the next page of Content Wizard 316 (FIG. 3). Some Content Types 320 require additional information. For example, a link must include the location of the linked document in addition to the Displayed Text 318. Accordingly, the Content Wizard 316 may require the user to provide the location being linked to when creating a link to an internal web page 324, an external web page 326, or report 328. Depending on the Content Type 320 that was selected, the user may be taken to the next page of Content Wizard 316, or it may close and return the user to Modify View page 1000. If the user is taken to the next page of Content Wizard 316, she will be prompted to select a Target 330 for the new page item. The available targets are as follows: current window, new window, existing open window, and fill frame.

Once all required information has been entered for the new page item, Content Wizard 316 of FIG. 3 will automatically close and return the user to the Modify View page 1000. Clicking the “Done” button at any point during the process of creating a new page item with the Content Wizard 316 will assign default values to the new page item and return the user to the Modify View page 1000.

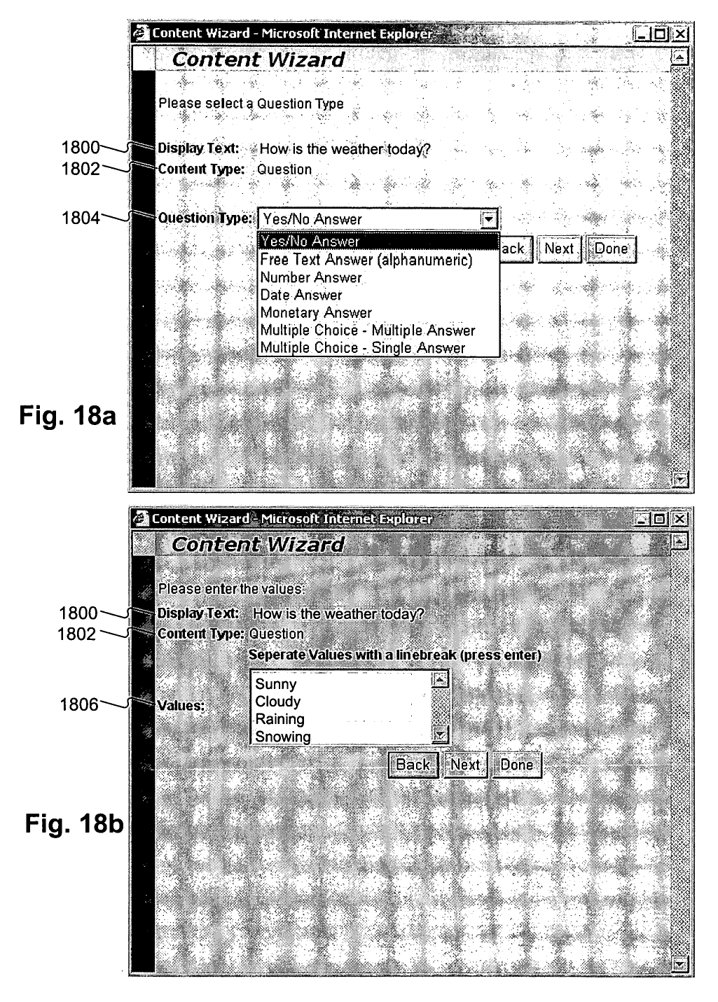

FIGS. 18a and 18b depict the user interface that may be displayed to add a survey question. Specifically, users can create interactive survey questions with the Content Wizard 316 (FIG. 3). The user enters the question in the Display Text 1800 field and selects “Question” as the Content Type 1802. Next, Content Wizard 316 prompts the user to select the Question Type 1804, for example: yes/no; multiple choice; free text fill-in; date; and so forth. The user thus supplies system 100 with two types of information: description data in the form of the user-entered question (e.g., the text entered by the user “How many items were undeliverable?”); and design data in the form of information supplied to system 100 detailing the structure and design of elements (e.g., whether the question type is yes/no or multiple choice). Some of the answer types will require additional steps to allow the user to enter text for the answer (e.g., multiple choice). Here, the user can enter the text associated with each answer in the Values 1806 field. Upon completing the fields required for the question, Content Wizard 316 returns the user to Modify View 1000 (FIG. 10). From Modify View 1000, the user may continue to insert additional questions by clicking on Add button 1001.

In the end, the user can create a number of questions that users and viewers alike can respond to when they subsequently view the final interactive survey on intranet 107. That is, as with other pages a user creates on system 100, an interactive survey created with the aid of Content Wizard 316 is accessible on intranet 107 after the user completes the requirements of development environment 200 and the data is stored in database 106 within production environment 210. Clearly, once created, an interactive survey serves the purpose of collecting information from authorized members. This information is sent to system 100 in the form of survey response data and can also be stored in database 106. Finally, system 100 allows certain users to later accumulate the authorized members'survey response data, create a report presenting the accumulated survey report data, and transmit the report in browser-accessible code to users and/or viewers.

Menu View

FIG. 11 depicts a web page that may be displayed to a user as Menu View page 1100 on system 100. This page allows users to modify menu 902 of FIG. 9. As authorized members view web pages on intranet 107 they can drag the mouse over menu 902 and view the sub-menus that appear as they scroll over the links. From Menu View page 1100 a user can add, update, delete, hide, or reorder items in the menu. Adding or editing a menu or sub-menu item will invoke Content Wizard 316. The user proceeds through the steps of Content Wizard 316, as explained above, but the styles and content types will vary slightly. Otherwise, Content Wizard 316 operates the same.

The user can change the order of the items on the menu or sub-menu. If the user highlights an item in either window 1101 or 1102, the user can use buttons to move the item up 1104 or down 1106. To save the new location the user simply clicks Save 1108. The revised order, however, will not appear on menu 902 of FIG. 9 until the menu is successfully deployed 1112.

As with the Modify View page 1000, users can Preview 1110 the menu 902 of FIG. 9 while still in the development environment 200 (FIG. 2). Clicking on Preview 1110 will allow the user to see what the menu 902 will look like, even though the menu has not been deployed to the production environment 210.

Menu Status 1114 displays the current status of the menu. This status note will help the user determine whether a new menu deployment should be made. If any changes have been made to the menu since the most recent deployment, the system will display the date and time of the last menu deploy. Any changes that have been made since this date/time are not active in the production environment and must be deployed to become active.

Report View

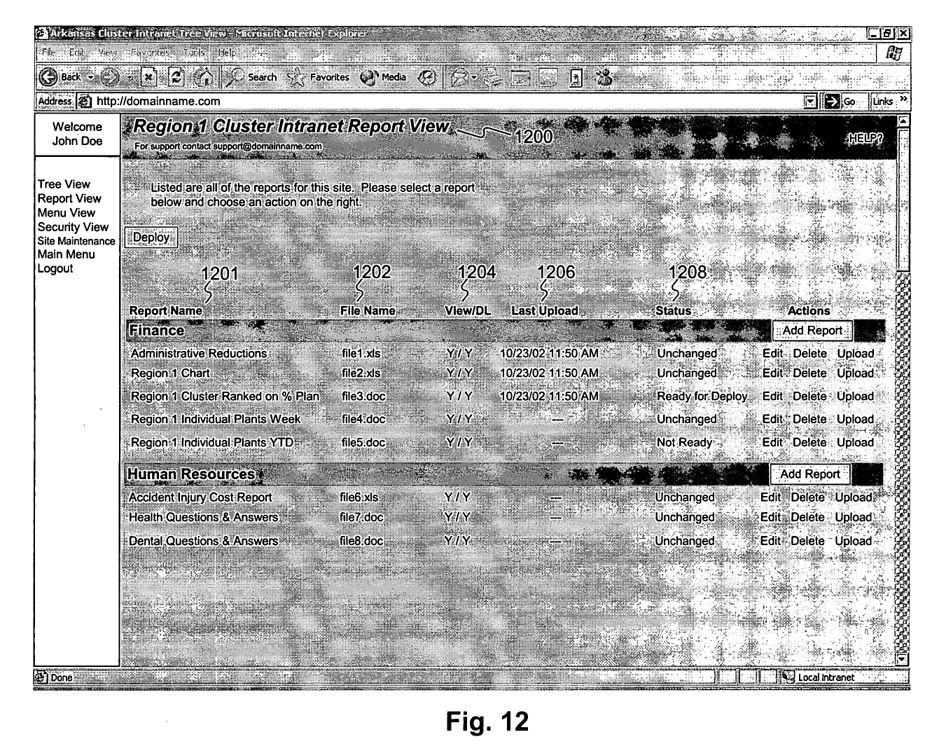

FIG. 12 depicts a web page that may be displayed to a user as Report View page 1200 on system 100. To access Report View page 1200, the user clicks on either the link listed in 400 or the link from menu 402 (FIG. 4). The Report View 1200 displays all reports that have been uploaded to intranet 107, grouped by category. This list, however, only contains those reports that the user can access. The page lists the report's name 1201, filename 1202, whether the report can be viewed or downloaded 1204, the last upload date 1206, and its current status 1208. Depending on the authorization level, the user may be allowed to add, delete, edit, upload, and deploy reports. “Editing” a report refers to editing the categories, not the report itself.

Security View

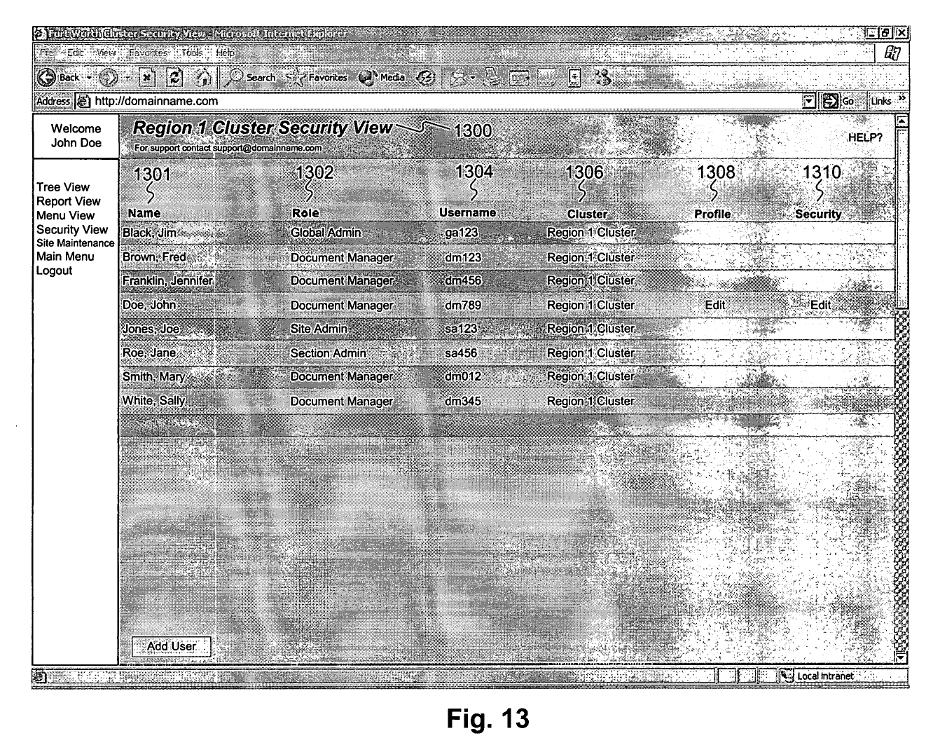

FIG. 13 depicts a web page that may be displayed to a user as Security View page 1300 on system 100. From here, users can be added or deleted, user profiles can be changed, and access to views, pages, and reports can be changed. All users with administrative access to the site are displayed. Many users, however, can only edit their own Profile 1308 or Security 1310 settings. Users will see the “Edit” links for only those users that they have authorization to modify. For example, John Doe is logged in to system 100 in FIG. 13 and can only edit his own profile.

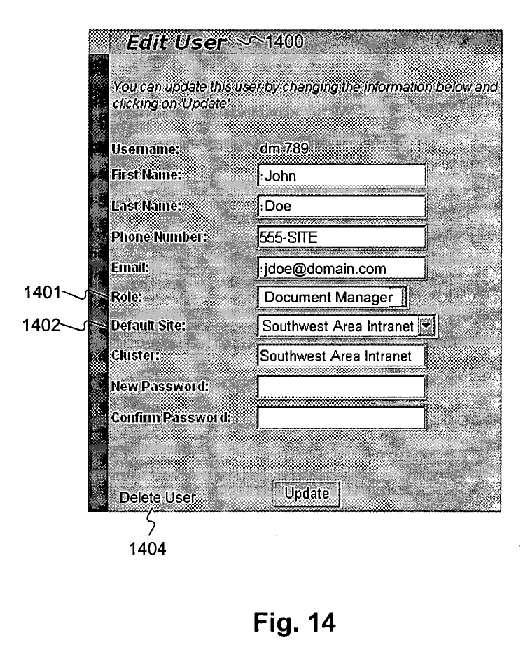

FIG. 14 depicts a web page that may be displayed to a user after clicking on “Edit” under the Profile 1308 column. Edit User window 1400 allows the user to modify a user's security profile. All users have access to their own profile where they can update and change the password. Users can only edit the profile or change the password of users for which they have access. The Default Site 1402 of a user can only be changed by a Global Administrator, and the Role 1401 of a user can only be changed to a role of equal or lesser privilege (e.g., from Section Administrator to Document Manager). For any changes made to a user, the user may need to log out and log back in before the changes will take affect. Users may also delete another user by clicking on Delete User 1404 (assuming they have the authorization).

FIG. 15 depicts a web page that may be displayed to a user after clicking on “Edit” under the Security 1310 column. User Access page 1500 is used to grant or remove specific access actions 1502 on each view. The actions available are dependent upon the administering user's role (e.g., Site Administrator) as well as the role of the selected user. Users are not allowed to change their own access actions 1502, and access actions cannot be changed for Global or Site Administrators. For any changes made to a user, the user may need to log out and log back in before the changes will take affect.

The security attributes of Global Administrators and Site Administrators may not be changed. By default, the roles of these users imply that they have access to all areas of the specified site. The security attributes for Section Administrators and Document Managers, however, may be edited. Section Administrators are allowed to access pages, reports, and security sections of the site. Global and Site Administrators may allow or prevent Section Administrators within their area to have access to specific portions of the site. Document Managers are allowed access to the reports section of the site only because these users are only allowed to help with the management of reports. Further, Global, Site, and Section Administrators may allow or prevent document managers within their area to have access to edit, upload, and/or deploy reports.

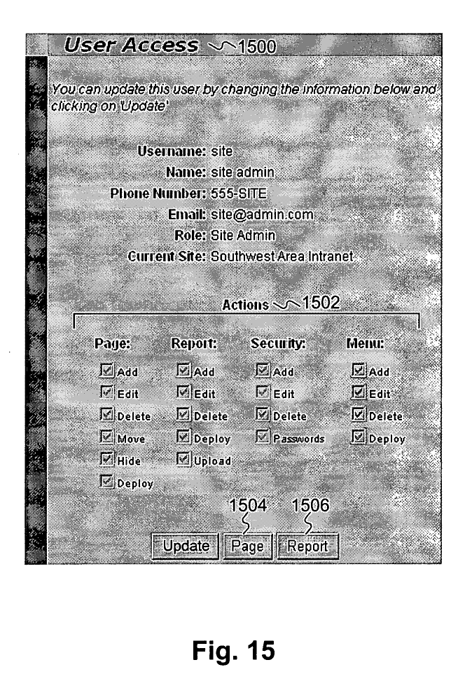

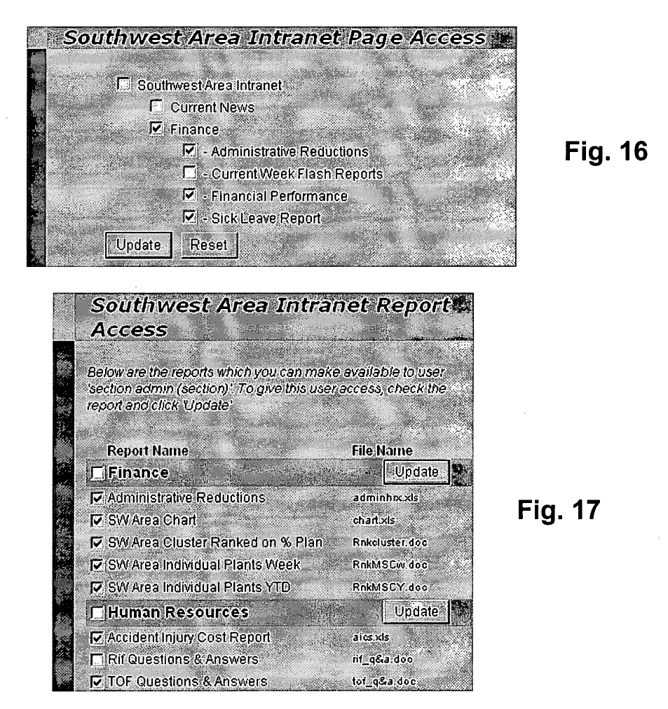

To identify the specific pages a Section Administrator can access, the administering user (i.e., Global or Site Administrator) should select the Page button 1504 at the bottom of User Access window 1500. This will display a Page Access window (FIG. 16), which allows the user to specify the pages the Section Administrator can access. Similarly, to specify the reports a Document Manager or Section Administrator can access, the administering user should select the Report button 1506 at the bottom of User Access window 1500. This will display a Report Access window (FIG. 17), which allows the user to specify the reports the Document Manager or Section Administrator can access.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for creating and administering web content on an intranet, comprising:
receiving survey request page design data and description data from a user;
generating survey request page design instructions corresponding to the received survey request page design data;
storing the survey request page design data, design instructions, and description data in a database;
receiving a request from an authorized member to display a web page;
retrieving the stored design data, stored design instructions, and stored description data from the database;
generating browser-accessible code from the retrieved design data, the retrieved design instructions, and the retrieved description data; and
transmitting the browser-accessible code to the authorized member to display web content in the form of a survey request web page.

2. The method of claim 1 further comprising:
receiving survey response data from the authorized member; and storing the survey response data.

3. The method of claim 2 further comprising:
accumulating survey response data received from a plurality of authorized members;
creating a report in a format specified by the survey request page design data, the report incorporating the accumulated survey response data; and
transmitting the report in browser-accessible code.

4. The method of claim 1 further comprising:
receiving from the user at least one of revised design data and revised description data; and
modifying the survey request web page according to the revised design data and revised description data.

5. The method of claim 1 further comprising:
granting the user one of a plurality of access permission levels to manipulate web pages.

6. The method of claim 1 further comprising:
granting the user one of a plurality of security access permissions.

7. The method of claim 1 further comprising:
displaying to the user at least one of the structural organization and the status of web pages.

8. The method of claim 1 further comprising:
prompting the user to answer questions presented by a content wizard;
receiving the answers to the questions as description data; and
receiving design data corresponding to the description data.

9. The method of claim 1 wherein:
design data comprises a first-user-selected one of a plurality of web page structures.

10. The method of claim 9 wherein:
the web page structures comprise pre-defined screen display zones.

11. A system for creating and administering web content on an intranet, comprising:
a database;
an intranet terminal;
a script engine; and
a processor, the processor comprising:
a component for receiving survey request page design data and description data from a user over the intranet terminal;
a component for commanding the script engine to generate survey request page design instructions corresponding to the received survey request page design data;
a component for storing the survey request page design data, the design instructions, and the description data in a database;
a component for receiving a request over the intranet terminal from an authorized member to display a web page;
a component for retrieving the stored design data, stored design instructions, and stored description data from the database;
a component for generating browser-accessible code from the retrieved design data, the retrieved design instructions, and the retrieved description data; and
a component for transmitting the browser-accessible code over the intranet terminal to the authorized member to display web content in the form of a survey request web page.

12. The system of claim 11, the processor further comprising:
a component for receiving survey response data over the intranet terminal from the authorized member; and
a component for storing the survey response data;

13. The system of claim 12, the processor further comprising:
a component for accumulating survey response data received from a plurality of authorized members;
a component for creating a report in a format specified by the survey request page design data, the report incorporating the accumulated survey response data; and
a component for transmitting the report over the intranet terminal in browser-accessible code.

14. The system of claim 11, the processor further comprising:
a component for receiving from the user over the intranet terminal at least one of revised design data and revised description data; and
a component for modifying the survey request web page according to the revised design data and revised description data.

15. The system of claim 11, the processor further comprising:
a component for granting the user one of a plurality of access permission levels to manipulate web pages.

16. The system of claim 11, the processor further comprising:
a component for granting the user one of a plurality of security access permissions.

17. The system of claim 11, the processor further comprising:
a component for transmitting to the user over the intranet terminal at least one of the structural organization and status of web pages.

18. The system of claim 11, the processor further comprising:
a component for transmitting prompts over the intranet terminal to the user to answer questions presented by a content wizard;
a component for receiving over the intranet terminal answers to the questions as description data; and
a component for receiving design data over the intranet terminal corresponding to the description data.

19. The system of claim 11 wherein:
design data consists of a first-user-selected one of a plurality of web page structures.

20. The system of claim 19 wherein:
the web page structures comprise pre-defined screen display zones.

21. A computer-readable medium having computer-executable instructions directing a computer to perform a method for creating and administering web content on an intranet, comprising the steps of:
receiving survey request page design data and description data from a user;
generating survey request page design instructions corresponding to the received survey request page design data;
storing the survey request page design data, design instructions, and description data in a database;
receiving a request from an authorized member to display a web page;
retrieving the stored design data, stored design instructions, and stored description data from the database;
generating browser-accessible code from the retrieved design data, the retrieved design instructions, and the retrieved description data; and
transmitting the browser-accessible code to the authorized member to display web content in the form of a survey request web page.
